(19) United States
(12) Patent Application Publication
(10) Pub. No.: US 2003/0131852 A1
(43) Pub. Date: Jul. 17, 2003

(54) Registration and surgical face mask

(75) Inventors: Helen Zinreich Shafer, Owings Mills, MD (US); Eva Zinreich, Owens Mills, MD (US)

Correspondence Address: HAHN LOESER & PARKS, LLP, TWIN OAKS ESTATE, 1225 W. MARKET STREET, AKRON, OH, 44313, US

(73) Assignee: IZI Corporation

(21) Appl. No.: 10/317,768

(22) Filed: Dec. 11, 2002

Related U.S. Application Data
(60) Provisional application No. 60/339,209, filed on Dec. 11, 2001.

(51) Int. Cl. A62B 18/08

(52) U.S. Cl. 128/206.21; 128/206.27

(57) ABSTRACT

The present invention is a face mask for use with registration of a patient's anatomy through medical imaging for image-guided surgical procedures. The mask includes a nasal bridge mount, medial orbital mounts and at least one side member which extends from the sides of the mask toward the patient's ears when in use. In a preferred embodiment, the face mask includes two side members which extend along the patient's head and behind the ears, similar to a pair of eyeglasses. The mask may also include a strap or other means for maintaining the mask upon the patient's head. The mask may be used to retain and position fiducial markers or attachment of medical or surgical instruments, such as tracking devices, for use during image-guided surgical procedures.

### CROSS-REFERENCE TO RELATED APPLICATIONS

This application claims the benefit of U.S. Provisional Application No. 60/339,209, filed Dec. 11, 2001. Application serial No. 60/339,209 is hereby incorporated by reference.

### TECHNICAL FIELD

The present invention relates to registration masks used for medical imaging and image-guided surgical procedures.

### BACKGROUND OF THE INVENTION

Three-dimensional medical imaging and image-guided surgery have advanced tremendously during the previous decade. One reason for this advancement is the development of complex computer software applications that create a three-dimensional display of a patient's anatomy from digitized imaging data. Three-dimensional reconstructions of human anatomy provide greater delineation between normal tissue and pathological tissue. Such three-dimensional images can be manipulated and viewed from virtually any orientation. Prerecorded images may be displayed during a surgical procedure to provide the surgeon with illustrative reference mappings of pertinent portions of a patient's body.

Registration of actual patient anatomy onto a digitized imaging display in the operating or treatment room is a crucial step in any image-guided surgical procedure. The most accurate method of registration used today uses fiducial markers attached directly to the patient's head as reference points for the surgical procedure. However, this method requires a scan to be performed specifically for the purpose of registration and precludes the use of radiographic data from other institutions.

Tracking systems for monitoring the position of a medical instrument have also been developed for use with image display systems. Such tracking systems typically involve either the use of a passive articulated arm attached to the medical instrument, optical detection, or ultrasonic detection. Currently used registration devices require that an additional support apparatus be fixed to the patient's head to support such tracking systems. Additionally, with such a tracking system, the patient frequently requires re-registration during surgery or treatment.

Accordingly, there is a need for a registration device that eliminates the need for medical imaging specifically for the purpose of registration. There is also a need for such a device which provides the capability for attachment of other medical instruments, such as tracking systems, which would eliminate the need for re-registration during surgery. Additionally, there is a need for a registration device with improved accuracy and repeatability. Accordingly, the present invention is hereby submitted.

### SUMMARY OF THE INVENTION

A face mask (“mask”) for use in conjunction with registration of a patient's anatomy and with an image-guided surgical procedure is hereby presented. The mask comprises a nasal bridge mount, medial orbital mounts, and two side members that extend over the patient's ears along the side of the head. In a preferred embodiment, side members extend along the patient's head and behind the ears, similar to a pair of eyeglasses. Additionally, the mask may include a means for securing the mask to the patient's head, such as a strapping mechanism.

A preferred embodiment of the mask further comprises a plurality of indentations on the surface of the mask. The indentations aid in the attachment of fiducial markers at specific and repeatable locations. In a preferred embodiment, the mask additionally comprises a means for attaching other instruments that are used in an image-guided surgical procedure. Such instruments include, but are not limited to, tracking devices.

### SUMMARY OF THE DRAWINGS

FIG. 1 is a perspective view of the mask with instrument attachments and securing straps in accordance with a preferred embodiment of the present invention.

FIG. 2 is a left rear perspective view of the mask with securing straps but without instrument attachments in accordance with a preferred embodiment of the present invention.

FIG. 3 is a front view of the mask with instrument attachments but without securing straps in accordance with a preferred embodiment of the present invention.

FIG. 4 is a perspective view of an instrument attachment in accordance with a preferred embodiment of the present invention.

FIG. 5 is a perspective view of the mask with instrument attachments, securing straps, and side members that curve over a patient's ears, in accordance with a preferred embodiment of the present invention.

### DETAILED DESCRIPTION OF THE INVENTION

Reference will now be made in detail to the present preferred embodiments of the invention as illustrated in the accompanying drawings. Whenever possible, the same reference numbers will be used throughout the drawings to refer to the same or like parts.

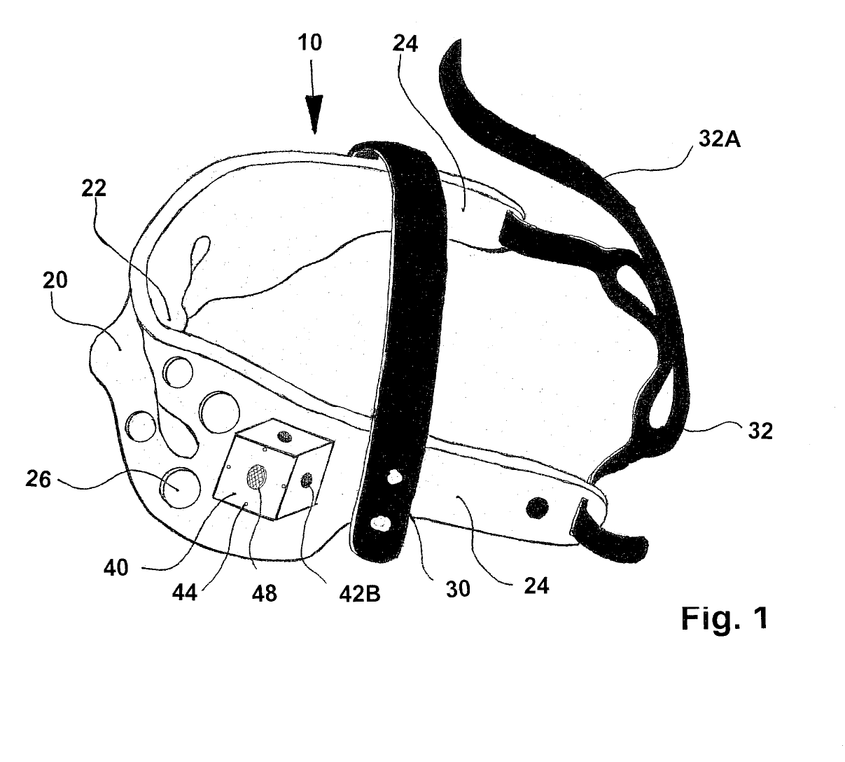

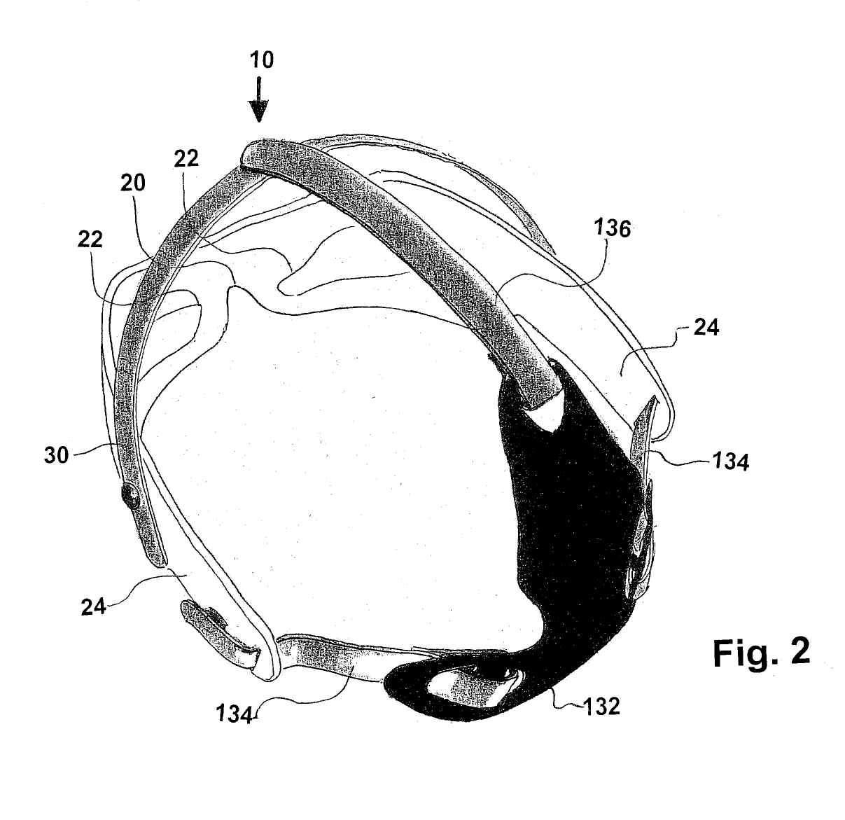

A preferred embodiment of a registration face mask (“mask”) 10 is illustrated in FIGS. 1 and 2. In a preferred embodiment, mask 10 comprises a face plate member with a nasal bridge mount 20 and medial orbital mounts 22, two side members 24 extending from the face plate, and a plurality of indentations 26 for attachment of fiducial markers. The face plate member of mask 10 generally overlays an area of a person's face above and below the eyes, and side members 24 extend from the face plate member along the temple region, over the ears, and optionally behind the ears.

Mask 10 is preferably constructed of a rigid and radioparent plastic, so that it may be snugly attached to a patient's head while non-detectable to imaging scans. In a preferred embodiment, mask 10 is comprised of polyethylene. The required thickness of mask 10 can vary with type of material utilized. Preferably, the thickness of the material should be sufficient for mask 10 to resist deformity and to accommodate indentations 26.

Additionally, mask 10 may be provided in a variety of sizes to accommodate a variety of patients. Preferably, the size and shape of mask 10 is based from reported normal facial measurement averages. Due to the differences among ages, genders and ethnicities with regard to average facial measurements, mask 10 may be provided in predetermined sizes and shapes that accommodate such age, gender and ethnic differences.

Preferably, mask 10 comprises two apertures for the person's eyes, so that when mask 10 is worn, the eyes of the person are not shielded and the person can see without significant obstruction. However, it is also contemplated that mask 10 can constructed without apertures for the person's eyes, such that the person's eyes are covered.

A primary objective of mask 10 is to provide a reference unit that may be easily attached to and removed from a patient's head, wherein mask 10 may be repeatedly reattached in exactly the same place with a high degree of accuracy and repeatability. To achieve this end, mask 10 comprises nasal bridge mount 20 and medial orbital mounts 22.

Nasal bridge mount 20 contacts selective portions of both sides of the patient's nose. Thus, nasal bridge mount 20 enables mask 10 to be worn in substantially the same horizontal position relative to the patient's face each time the patient wears mask 10. Medial orbital mounts 22 are formed by turning inwardly a portion of the upper perimeter of the orbital apertures, forming a lip-like structure. Thus, medial orbital mounts 22 contour to an upper medial portion of the patient's orbital sockets and enable mask 10 to be positioned in substantially the same vertical position relative to the patient's face each time the patient wears mask 10.

The three-point positioning of nasal bridge mount 20 and medial orbital mounts 22, together with side members 24 that rest on the person's ears, ensures that each time the same patient wears mask 10, it is positioned in substantially the same position relative to the patient's head. Consequently, the fiducial markers will be positioned in substantially the same position relative to the patient's head. In addition to this repeatability, mask 10 is comfortable for the person to wear for extended periods of time, similar to a pair of eyeglasses.

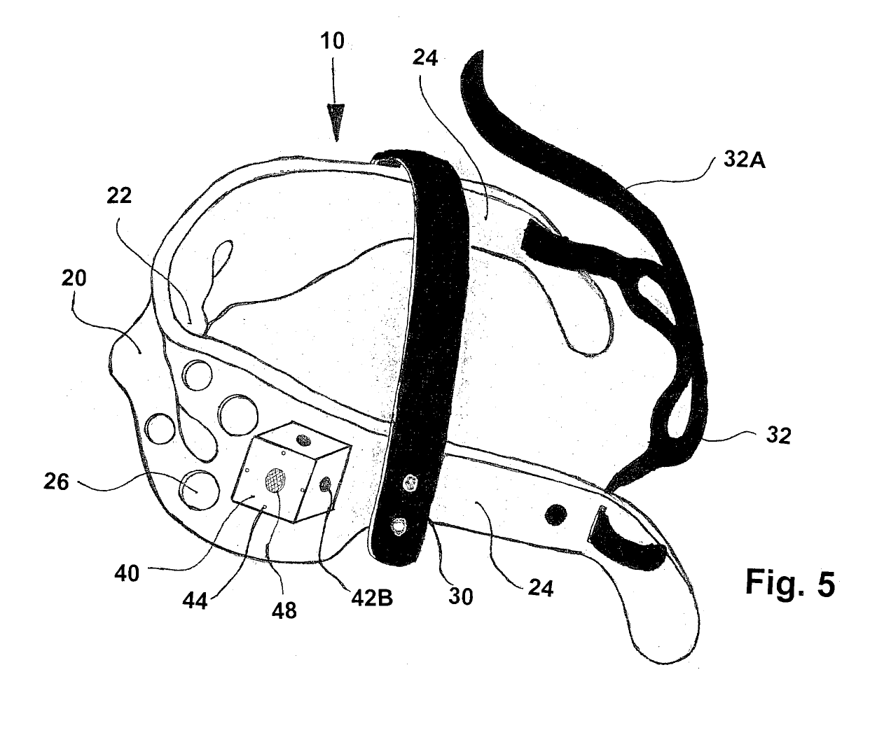

Side members 24 extend along the sides of the head of the patient. In a preferred embodiment, side members 24 extend a length sufficient to rest on a person's ear, similar to a pair of glasses. Side members 24 are preferably substantially straight, so that they rest on the person's ear at the junction between the head and the ear. However, as illustrated in FIG. 5, it is also contemplated that a distal portion of side members 24 can curve downwardly so that side members 24 generally follow the contour of the ear, similar to a pair of eyeglasses. In this manner, side members 24 would aid in stabilizing mask 10 from forward movements relative to the person's head.

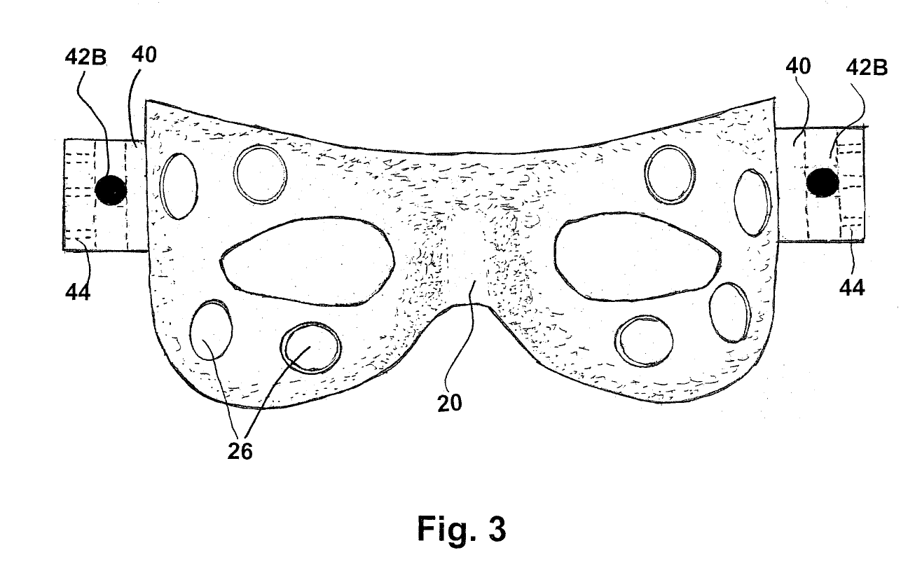

Optional indentations 26 that receive fiducial markers are illustrated in FIGS. 1 and 3. Indentations 26 receive fiducial markers that are known in the art. The size and shape of indentations 26 can vary according to the predetermined size of the fiducial markers used. Each time a patient wears mask 10, the fiducial markers will be located in the same position relative to mask 10, and therefore the patient's head. This ability to re-position fiducial markers at the same position relative to mask 10, and therefore a person's head, enables a previous imaging scan to be used to correlate a person's anatomy, simply by reattaching mask 10 with fiducial markers.

Other embodiments of fiducial marker positioners are contemplated. The fiducial markers can be permanently attached to or embedded within mask 10. Alternatively, mask 10 could have superficial markings or protrusions by which fiducial markers are positioned, or any of a plurality of other positioning means as are known in the art can be utilized without deviating from the scope of the present invention.

In a preferred embodiment, mask 10 further comprises a means for securing mask 10 to a patient's head. A variety of means are contemplated that accomplish the intended purpose, which is to attach the mask to the patient's head securely. One preferred means for securing mask 10 to a person's head, as illustrated in FIG. 1, comprises first strap 30 and second strap 32. First strap 30 extends over of the person's head. Respective ends of strap 30 fasten to side members 24 by any of a plurality of fasteners known in the art. First strap 30 can be comprised of an elastic or non-elastic material, and is preferably selectively adjustable to accommodate different sizes of heads.

Second strap 32 extends around the back of the patient's head, and therefore prevents forward movement of mask 10 relative to the patient's head. Second strap 32 can again be comprised of an elastic or non-elastic material. Respective ends of second strap 32 fasten to side members 24 by any of a plurality of fasteners known in the art. Preferably, second strap 32 is selectively adjustable to accommodate different sizes of heads.

In a preferred embodiment, second strap 32 further comprises a spanning appendage 32A that connects second strap 32 to first strap 30 near the midpoint of first strap 30. By connecting first strap 30 to second strap 32, mask 10 further resists movement relative to the person's head. Optionally, spanning appendage 32A could attach to the top of the face plate. Spanning appendage 32A is preferably fastened to first strap 30 by VELCRO® brand hook and loop fasteners, but again any of a plurality of fasteners known in the art are contemplated.

Alternative embodiments of means for securing mask 10 to a person's head are contemplated. As seen in FIG. 2, the second strap can be comprised of a central support piece 132 with two removable straps 134 that fasten to side members 24, and a third removable strap 136 that fastens to first strap 30. It is also contemplated that first strap 30 can be eliminated, whereby third removable strap 136 attaches directly to mask 10, or any of a plurality of means for securing mask 10 to a person's head could be utilized without deviating from the scope of the present invention.

The present invention may also function as a holder for other medical or surgical instruments during an image-guided surgical procedure. Therefore, a further embodiment of mask 10 comprises instrument attachments 40. Instrument attachments 40 permit selective attachment of any of a plurality of instruments used in image-guided surgical procedures. Such instruments include, but are not limited to, tracking devices. By attaching other instruments to mask 10, the position of the instrument relative to mask 10, and therefore relative to the patient's head, remains constant.

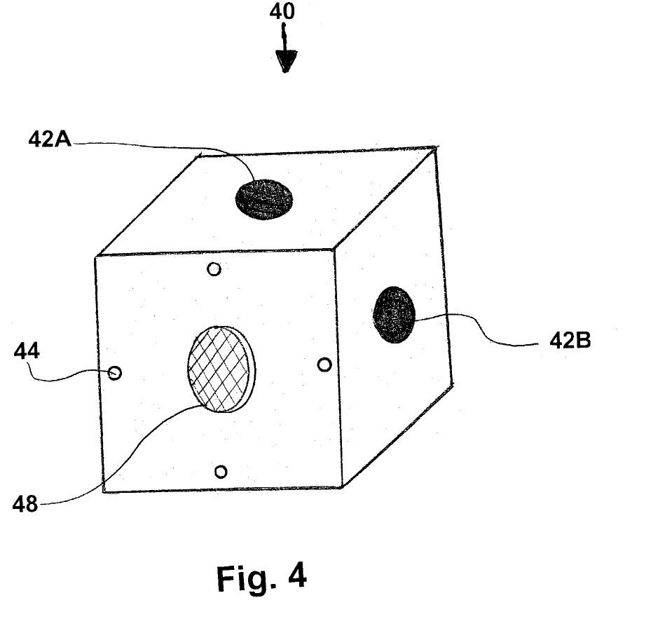

A preferred embodiment of an instrument attachment 40, illustrated in FIGS. 1 and 4, generally comprises a cube with a plurality of apertures 42A and 42B extending through the cube. It is contemplated that the specific size and shape of instrument attachment 40 can vary in accordance with the instruments desired to be attached. Instrument attachment 40 is preferably constructed of a rigid plastic, but any of a plurality of radioparent materials as are known in the art can be utilized. Instrument attachments 40 are selectively attached to mask 10 by any of a plurality of means known in the art, including, but not limited to, plastic screws or thermal welding.

Apertures 42A and 42B receive the medical or surgical instruments, or portions thereof. One aperture 42A extends vertically through the center of the cube and another aperture 42B extends horizontally through the center of the cube. However, it is contemplated that apertures 42A and 42B can be any of a plurality of different numbers, diameters, shapes, and orientations as necessary or desired for the instrument to be attached.

Instrument attachments 40 additionally comprise a means for securing the medical or surgical instruments within apertures 42A and 42B. A preferred embodiment for securing instruments within apertures 42A and 42B comprises screw holes 44 and screws 48. Screw holes 44 extend into apertures 42A and 42B, and receive screws 48. Screws 48 are of sufficient length to extend into the desired aperture 42A or 42B when screws 48 are engaged in screw holes 44. Therefore, screws 48 can apply force to the inserted medical or surgical instrument when screws 48 are engaged with holes 44.

In operation, the technician or physician inserts the desired instrument or portion thereof into one of the apertures 42A or 42B. After the instrument is fully inserted within the desired aperture 42A or 42B, the user tightens one or more screws 48 into the corresponding screw hole 44 until screw 48 applies sufficient force to the medical or surgical instrument to secure it within the aperture. Other means for securing a medical or surgical instrument within an aperture 42A or 42B are contemplated, including, but not limited to, threaded apertures 42A and 42B, friction actuation, pins, and any of a plurality of other means known in the art.

The foregoing disclosure is illustrative of the present invention and is not to be construed as limiting thereof. Although one or more embodiments of the invention have been described, persons of ordinary skill in the art will readily appreciate that numerous modifications could be made without departing from the scope and spirit of the disclosed invention. As such, it should be understood that all such modifications are intended to be included within the scope of this invention. The written description and drawings illustrate the present invention and are not to be construed as limited to the specific embodiments disclosed.

What is claimed is:

1. A face mask for use as an aid in registration of a person's anatomy comprising a face plate member, at least one side member extending from each side of the face plate member and at least one region for receiving fiducial markers,
said face plate member comprising a nasal bridge mount and medial orbital mounts that position the face mask in substantially the same position relative to the person's face each time the person wears the face mask.

2. A face mask as recited in claim 1, wherein said at least one side member rests on the person's ear.

3. The face mask as recited in claim 1, further comprising a means for selectively securing the face mask to the person's head.

4. The face mask as recited in claim 1, further comprising a means for selectively attaching a medical or surgical instrument to the face mask.

5. The face mask as recited in claim 1, wherein said face mask is made from radioparent material.

6. The face mask as recited in claim 5, wherein said radioparent material is plastic.

7. The face mask as recited in claim 6, wherein said material is polyethylene.

8. A face mask for use as an aid in registration of a person's anatomy comprising a face plate member, at least one side member extending from each side of the face plate member and at least one means for selectively attaching a medical or surgical instrument to the face mask,
said face plate member comprising a nasal bridge mount and medial orbital mounts that position the face mask in substantially the same position relative to the person's face each time the person wears the face mask.

9. A face mask as recited in claim 8, wherein said at least one side member rests on the person's ear.

10. The face mask as recited in claim 8, further comprising a means for selectively securing the face mask to the person's head.

11. The face mask as recited in claim 8, wherein said face mask is made from radioparent material.

12. The face mask as recited in claim 11, wherein said radioparent material is plastic.

13. The face mask as recited in claim 12, wherein said material is polyethylene.

14. A method of registration of a person's anatomy comprising the steps of selectively attaching fiducial markers to predetermined locations on a face mask, securing the face mask to the person's head in a substantially repeatable manner, performing an imaging scan of the person's head, and registering the person's anatomy.
